(19) United States
(12) Patent Application Publication
(10) Pub. No.: US 2016/0186874 A1
(43) Pub. Date: Jun. 30, 2016

(54) Air Valve Structure for Inflatable Air Cushion

(71) Applicant: Feng Yi Outdoor Leisure Equipment Enterprise Co., Ltd., Taichung City (TW)

(72) Inventor: Cindy Lin, Taichung City (TW)

(21) Appl. No.: 14/587,127

(22) Filed: Dec. 31, 2014

(51) Int. Cl. F16K 15/20

(52) U.S. Cl. CPC F16K 15/202

(57) ABSTRACT

A air valve structure includes a base, a valve seat, a valve cover and a valve plate. The base is provided with a mounting hole. The valve seat is provided with a first mounting portion and a second mounting portion. The first mounting portion and the second mounting portion of the valve seat are mounted in the mounting hole of the base at different time. The valve seat is provided with a vent hole. The valve seat is provided with a support portion and an abutting edge. The valve cover is provided with a covering portion. Thus, the air valve structure functions as a oneway valve by action of the valve plate to provide a oneway air inlet or outlet function.

### BACKGROUND OF THE INVENTION

1. Field of the Invention

The present invention relates to a valve structure and, more particularly, to an air valve structure for an inflatable air cushion that is operated manually or automatically.

2. Description of the Related Art

A conventional air valve structure in accordance with the prior art shown in FIGS. 17 and 18 comprises a base 43, a vent hole 44 and a cover 45. The conventional air valve structure is mounted on the top of an inflatable air cushion 40 which is operated manually. The inflatable air cushion 40 includes an upper surface layer 41 and a lower surface layer 42 combined and sealed by a high frequency wave. The base 43 is secured in the upper surface layer 41 of the inflatable air cushion 40. In operation, when the inflatable air cushion 40 is expanded by an inflator during the air inflation process, the intake air is forced by the inflator to flow through the vent hole 44 into the inflatable air cushion 40 so as to inflate the inflatable air cushion 40. After inflation of the inflatable air cushion 40 is finished, the cover 45 is mounted on the base 43 to close the vent hole 44. However, when the inflator stops operating to stop the air inflation process, the air pressure in the inflatable air cushion 40 is greater than that outside of the inflatable air cushion 40, so that the air in the inflatable air cushion 40 easily leaks outward from the inflatable air cushion 40, thereby decreasing the air inflation effect. On the contrary, the cover 45 is removed from the base 43 to open the vent hole 44. Then, the inflatable air cushion 40 is folded and compressed to force the air in the inflatable air cushion 40 to drain outward from the vent hole 44 so as to deflate the inflatable air cushion 40. After deflation of the inflatable air cushion 40 is finished, the cover 45 is mounted on the base 43 to close the vent hole 44. However, when the air deflation process is finished, the air pressure in the inflatable air cushion 40 is smaller than that outside of the inflatable air cushion 40, so that the ambient air easily flows through the vent hole 44 into the inflatable air cushion 40, thereby decreasing the air deflation effect.

Another conventional air valve structure in accordance with the prior art shown in FIGS. 19 and 20 comprises a valve seat 55, a valve tube 54 and a valve cover 541. The valve tube 54 has a vent hole 542. The conventional air valve structure is mounted on a side of an inflatable air cushion 50 which is operated automatically. The inflatable air cushion 50 includes an upper surface layer 51 and a lower surface layer 52 combined and sealed by a high frequency wave, and a sponge layer 53 mounted between the upper surface layer 51 and the lower surface layer 52. The valve seat 55 is secured in the upper surface layer 51 and the lower surface layer 52. When in use, air is driven into the valve tube 54 to expand the inflatable air cushion 50. However, partial of the air in the inflatable air cushion 50 easily leaks outward when the air inflation process is finished, thereby decreasing the air inflation effect. On the contrary, the ambient air easily flows into the inflatable air cushion 50 when the air deflation process is finished, thereby decreasing the air deflation effect.

BRIEF SUMMARY OF THE INVENTION

In accordance with the present invention, there is provided an air valve structure comprising a base, a valve seat, a valve cover and a valve plate. The base is provided with a mounting hole. The valve seat is provided with a first mounting portion and a second mounting portion. The first mounting portion and the second mounting portion of the valve seat are mounted in the mounting hole of the base at different time. The valve seat is provided with a vent hole. The valve seat is provided with a support portion and an abutting edge each of which is disposed in the vent hole. The support portion of the valve seat is provided with a through hole for mounting the valve plate. The valve cover and the base are connected by a flexible connecting member. The valve cover is provided with a covering portion.

Preferably, the valve seat and the base are connected by a flexible connecting strip.

Alternatively, the valve seat is separated and disconnected from the base.

Preferably, the valve seat has a side provided with a grip portion.

Preferably, the valve plate is made of soft material, including silicone, plastics or rubber, and is formed integrally with a limit post extending through the through hole of the support portion of the valve seat. The limit post of the valve plate is provided with a limit protrusion.

Preferably, the valve plate has a diameter greater than an inner diameter of the abutting edge of the valve seat.

Preferably, the covering portion of the valve cover is mounted on the first mounting portion or the second mounting portion of the valve seat to seal the first mounting portion or the second mounting portion of the valve seat.

Preferably, the valve cover has a side provided with a grip portion.

According to the primary advantage of the present invention, the air valve structure functions as a oneway valve by action of the valve plate to provide a oneway air inlet or outlet function so as to enhance the air inflation or deflation effect.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an air valve structure for an inflatable air cushion in accordance with the preferred embodiment of the present invention.

FIG. 2 is a cross-sectional view of the air valve structure for an inflatable air cushion as shown in FIG. 1.

FIG. 3 is a perspective view of the air valve structure in accordance with the preferred embodiment of the present invention.

FIG. 4 is an exploded perspective view of the air valve structure as shown in FIG. 3.

FIG. 5 is a top view of the air valve structure as shown in FIG. 3.

FIG. 6 is a cross-sectional view of the air valve structure as shown in FIG. 3.

FIG. 7 is a schematic operational view of the air valve structure as shown in FIG. 6.

FIG. 8 is a schematic operational view of the air valve structure as shown in FIG. 7.

FIG. 9 is a schematic operational view of the air valve structure as shown in FIG. 8.

FIG. 10 is a schematic operational view of the air valve structure as shown in FIG. 7.

FIG. 11 is another schematic operational view of the air valve structure as shown in FIG. 6.

FIG. 12 is a schematic operational view of the air valve structure as shown in FIG. 11.

FIG. 13 is a schematic operational view of the air valve structure as shown in FIG. 12.

FIG. 14 is a cross-sectional view of an air valve structure for an inflatable air cushion in accordance with another preferred embodiment of the present invention.

FIG. 15 is a perspective view of the air valve structure for an inflatable air cushion as shown in FIG. 14.

FIG. 16 is an exploded perspective view of an air valve structure in accordance with another preferred embodiment of the present invention.

FIG. 17 is a perspective view of a conventional air valve structure for an inflatable air cushion in accordance with the prior art.

FIG. 18 is a cross-sectional view of the conventional air valve structure for an inflatable air cushion as shown in FIG. 17.

FIG. 19 is a perspective view of another conventional air valve structure for another inflatable air cushion in accordance with the prior art.

FIG. 20 is a cross-sectional view of the conventional air valve structure for another inflatable air cushion as shown in FIG. 19.

### DETAILED DESCRIPTION OF THE INVENTION

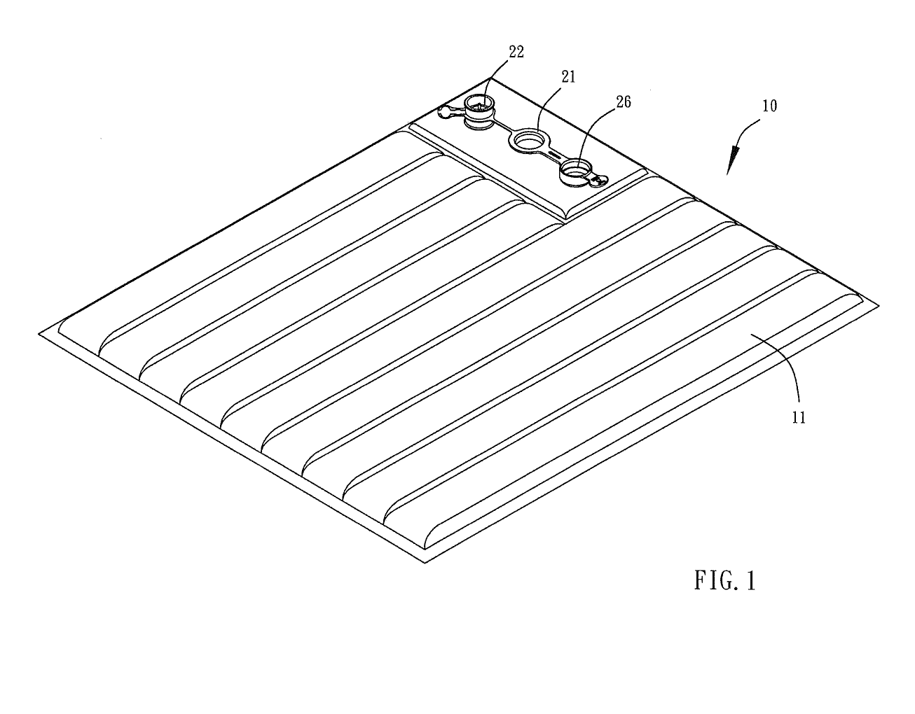

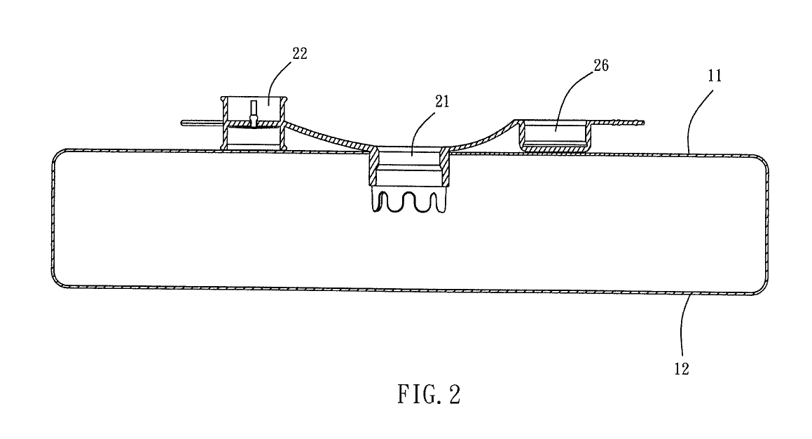

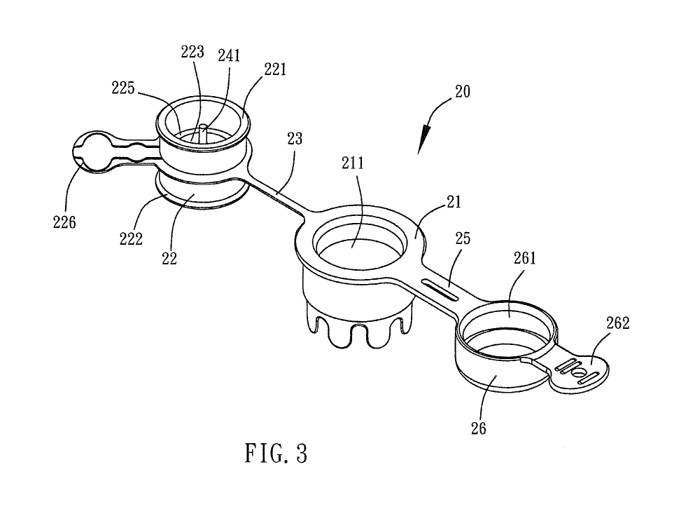

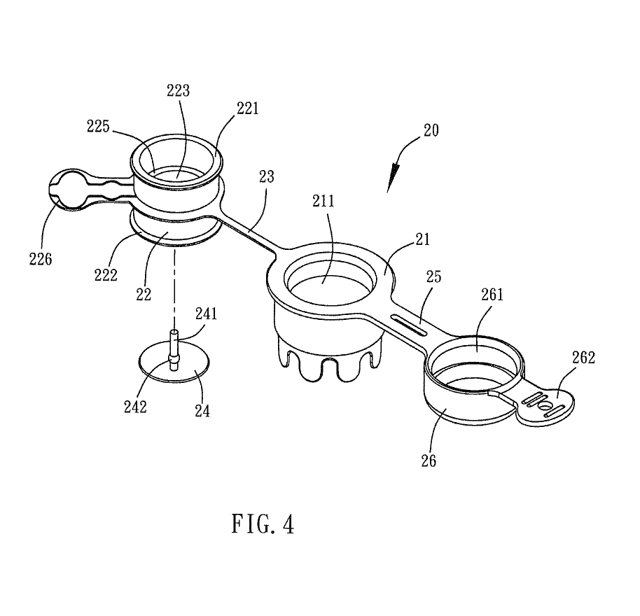

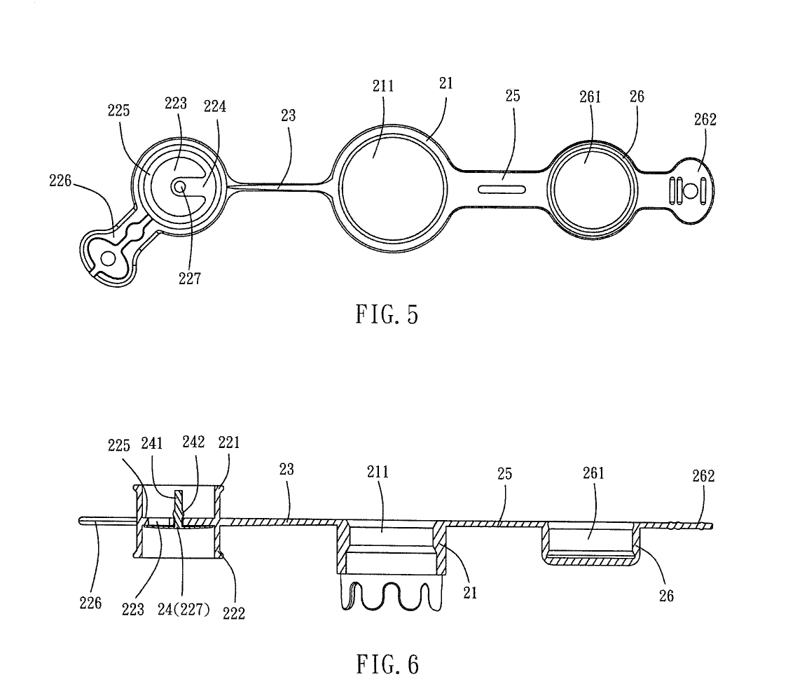

Referring to the drawings and initially to FIGS. 1-7, an air valve structure 20 in accordance with the preferred embodiment of the present invention comprises a base 21, a valve seat 22, a valve cover 26 and a valve plate 24.

The air valve structure 20 is mounted on the top of an inflatable air cushion 10 which is operated manually. The inflatable air cushion 10 includes an upper surface layer 11 and a lower surface layer 12 combined and sealed by a high frequency wave.

The base 21 has a cylindrical shape and is secured in the upper surface layer 11 of the inflatable air cushion 10. The base 21 is provided with a mounting hole 211 for mounting the valve seat 22. The mounting hole 211 of the base 21 is connected to the interior of the inflatable air cushion 10.

The valve seat 22 is provided with a first mounting portion 221 and a second mounting portion 222. The first mounting portion 221 and the second mounting portion 222 of the valve seat 22 are mounted in the mounting hole 211 of the base 21 at different time. The valve seat 22 is provided with a vent hole 223 connected to the mounting hole 211 of the base 21 when the valve seat 22 is mounted on the base 21. The valve seat 22 is provided with a support portion 224 and an abutting edge 225 each of which is disposed in the vent hole 223. The support portion 224 of the valve seat 22 is provided with a through hole 227 for mounting the valve plate 24. The valve seat 22 has a side provided with a grip portion 226. In the preferred embodiment of the present invention, the valve seat 22 and the base 21 are connected by a flexible connecting strip 23.

The valve cover 26 and the base 21 are connected by a flexible connecting member 25. The valve cover 26 is provided with a covering portion 261 mounted on the first mounting portion 221 or the second mounting portion 222 of the valve seat 22 to seal the first mounting portion 221 or the second mounting portion 222 of the valve seat 22. The valve cover 26 has a side provided with a grip portion 262.

The valve plate 24 is made of soft material, including silicone, plastics or rubber. The valve plate 24 is movable relative to the support portion 224 of the valve seat 22. The valve plate 24 is formed integrally with a limit post 241 extending through the through hole 227 of the support portion 224 of the valve seat 22. The limit post 241 of the valve plate 24 is movably mounted on the support portion 224 of the valve seat 22 and is provided with a limit protrusion 242 abutting the support portion 224 of the valve seat 22 so that the support portion 224 of the valve seat 22 is sandwiched between the valve plate 24 and the limit protrusion 242. The valve plate 24 has a circular shape and has a diameter greater than an inner diameter of the abutting edge 225 of the valve seat 22.

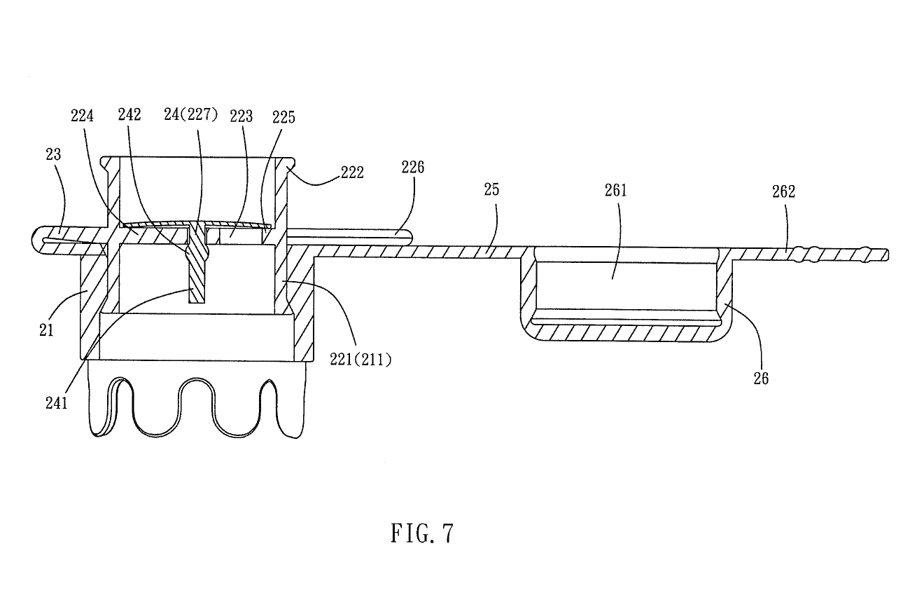

As shown in FIG. 7, the valve plate 24 is movably disposed in the second mounting portion 222 of the valve seat 22, the first mounting portion 221 of the valve seat 22 is mounted in the mounting hole 211 of the base 21, the second mounting portion 222 of the valve seat 22 protrudes outward from the base 21, and the covering portion 261 of the valve cover 26 is removed from the second mounting portion 222 of the valve seat 22.

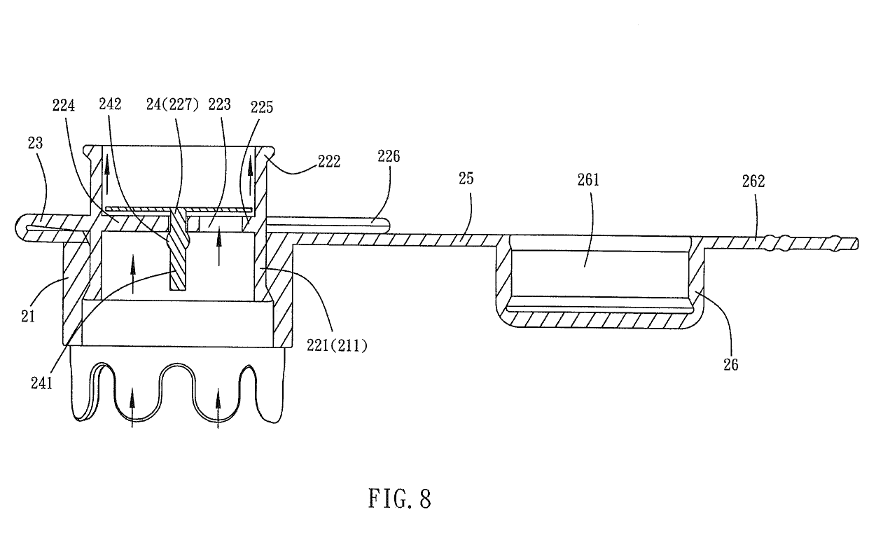

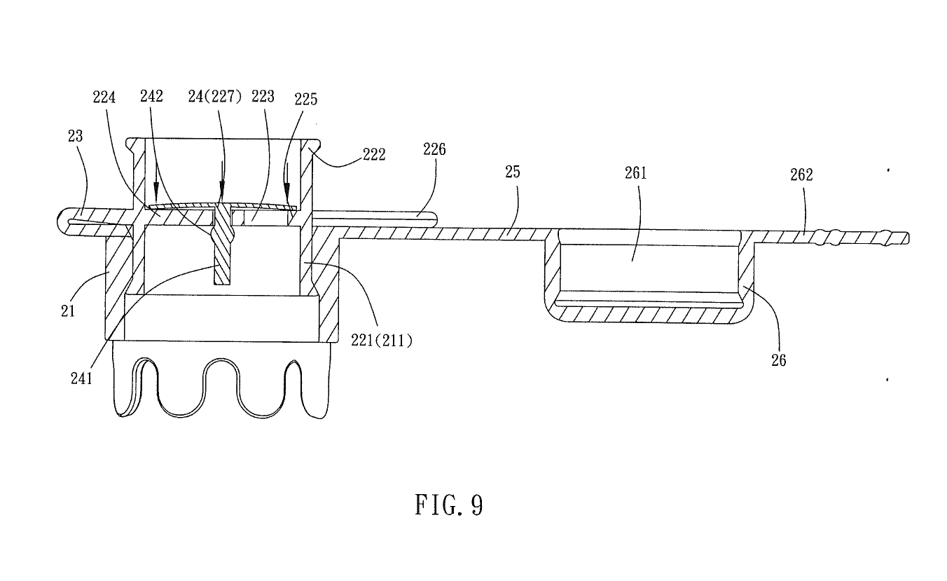

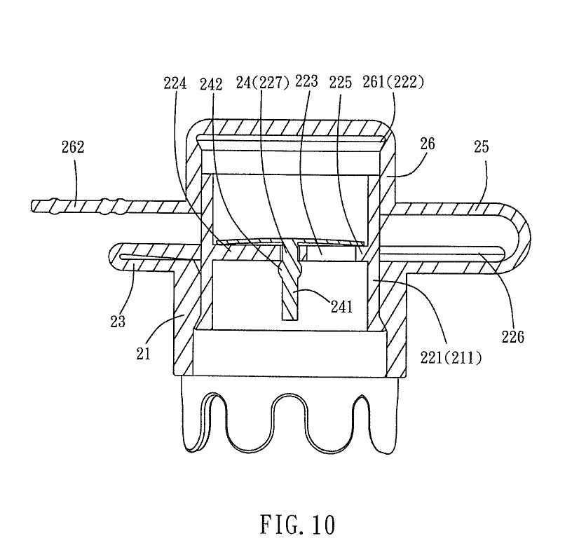

In operation, referring to FIGS. 8-10 with reference to FIGS. 1-7, when the inflatable air cushion 10 is compressed during the air deflation process, the air pressure in the inflatable air cushion 10 is greater than that outside of the inflatable air cushion 10, so that the air in the inflatable air cushion 10 is pressed to flow toward the mounting hole 211 of the base 21 and the vent hole 223 of the valve seat 22 to push the valve plate 24 upward so as to release the valve plate 24 from the vent hole 223 of the valve seat 22. In such a manner, the air in the inflatable air cushion 10 in turn flows through the mounting hole 211 of the base 21, the first mounting portion 221 of the valve seat 22, the vent hole 223 of the valve seat 22 and the second mounting portion 222 of the valve seat 22 as shown in FIG. 8 and is drained outward from the second mounting portion 222 of the valve seat 22. When the inflatable air cushion 10 is not compressed any more, the air pressure in the inflatable air cushion 10 is smaller than that outside of the inflatable air cushion 10, so that the valve plate 24 is pushed downward by the air pressure outside of the inflatable air cushion 10 to abut the support portion 224 and the abutting edge 225 of the valve seat 22 so as to seal the vent hole 223 of the valve seat 22 as shown in FIG. 9. In such a manner, the air outside of the inflatable air cushion 10 is stopped by the valve plate 24 and cannot enter the inflatable air cushion 10, so that the air valve structure 20 prevents the ambient air from returning the inflatable air cushion 10 during the air deflation process so as to enhance the air draining effect of the inflatable air cushion 10. After the air deflation process of the inflatable air cushion 10 is finished, the covering portion 261 of the valve cover 26 is mounted on the second mounting portion 222 of the valve seat 22 as shown in FIG. 10 to seal the valve seat 22.

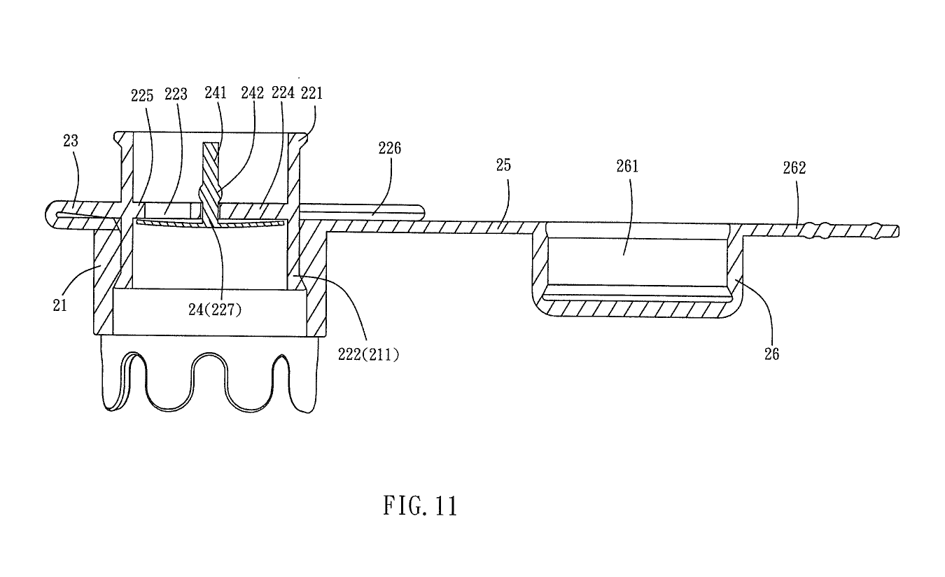

As shown in FIGS. 10 and 11, the covering portion 261 of the valve cover 26 is removed from the second mounting portion 222 of the valve seat 22, and the first mounting portion 221 of the valve seat 22 is detached from the mounting hole 211 of the base 21. Then, the valve seat 22 is inverted relative to the base 21 by the flexible feature of the connecting strip 23 to change the position of the first mounting portion 221 and the second mounting portion 222. Then, the second mounting portion 222 of the valve seat 22 is mounted in the mounting hole 211 of the base 21, and the first mounting portion 221 of the valve seat 22 protrudes outward from the base 21.

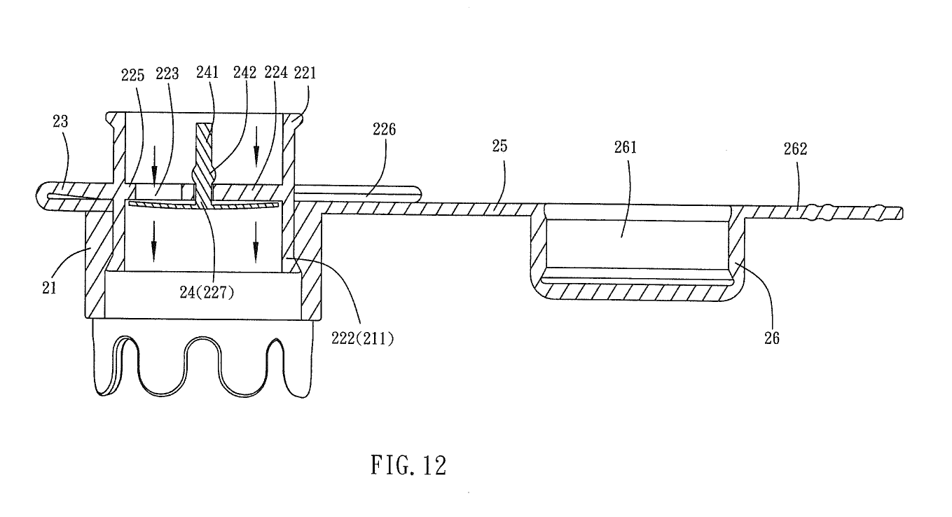

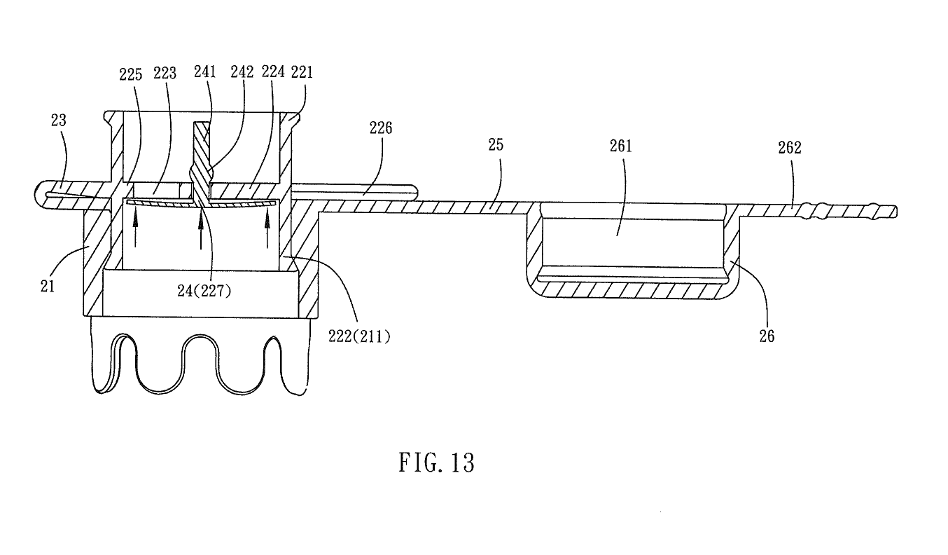

In operation, referring to FIGS. 12 and 13 with reference to FIG. 11, when the inflatable air cushion 10 is expanded by an inflator during the air inflation process, the air pressure in the inflatable air cushion 10 is smaller than that outside of the inflatable air cushion 10, so that the intake air is forced to flow toward the vent hole 223 of the valve seat 22 to push the valve plate 24 downward so as to release the valve plate 24 from the vent hole 223 of the valve seat 22. In such a manner, the intake air from the inflator in turn flows through the first mounting portion 221 of the valve seat 22, the vent hole 223 of the valve seat 22, the second mounting portion 222 of the valve seat 22 and the mounting hole 211 of the base 21 as shown in FIG. 12 into the inflatable air cushion 10 to inflate the inflatable air cushion 10. When the inflator stops operating to stop the air inflation process, the air pressure in the inflatable air cushion 10 is greater than that outside of the inflatable air cushion 10, so that the valve plate 24 is pushed upward by the air pressure in the inflatable air cushion 10 to abut the support portion 224 and the abutting edge 225 of the valve seat 22 so as to seal the vent hole 223 of the valve seat 22 as shown in FIG. 13. In such a manner, the air in the inflatable air cushion 10 is stopped by the valve plate 24 and cannot be drained outward from the inflatable air cushion 10, so that the air valve structure 20 prevents the air in the inflatable air cushion 10 from being leaked outward from the inflatable air cushion 10 during the air inflation process so as to enhance the air inflation effect of the inflatable air cushion 10.

In conclusion, when the first mounting portion 221 of the valve seat 22 is mounted in the mounting hole 211 of the base 21, the air valve structure 20 functions as a oneway valve by action of the valve plate 24 to prevent the ambient air from entering the inflatable air cushion 10 during the air deflation process, and when the second mounting portion 222 of the valve seat 22 is mounted in the mounting hole 211 of the base 21, the air valve structure 20 functions as a oneway valve by action of the valve plate 24 to prevent the air in the inflatable air cushion 10 from being drained outward from the inflatable air cushion 10 during the air inflation process

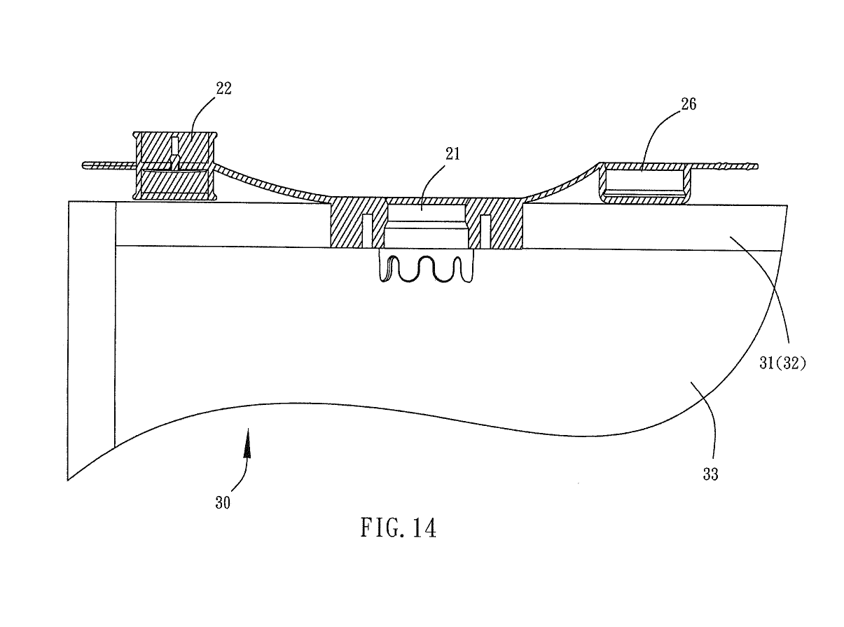

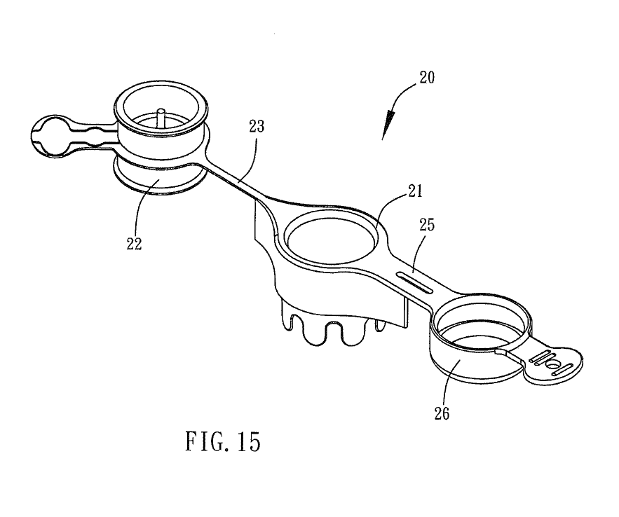

Referring to FIGS. 14 and 15, the air valve structure 20 is mounted on a side of an inflatable air cushion 30 which is operated automatically. The inflatable air cushion 30 includes an upper surface layer 31 and a lower surface layer 32 combined and sealed by a high frequency wave, and a sponge layer 33 mounted between the upper surface layer 31 and the lower surface layer 32. The base 21 has a diamond shape and is secured between the upper surface layer 31 and the lower surface layer 32.

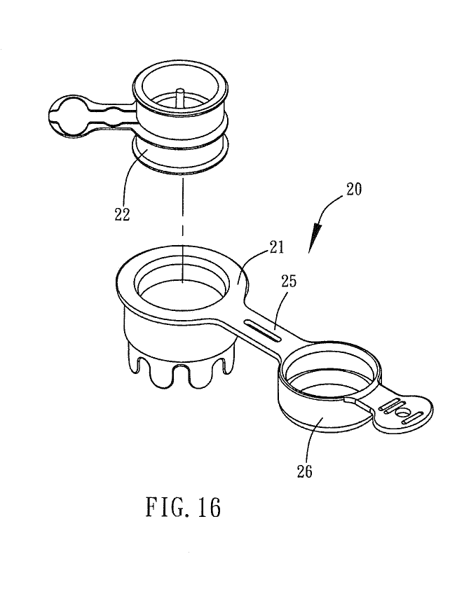

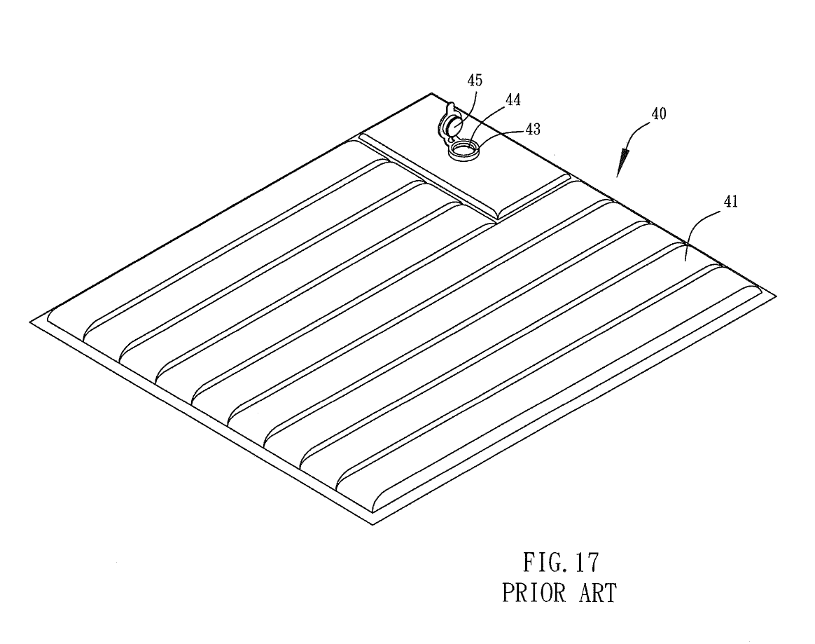

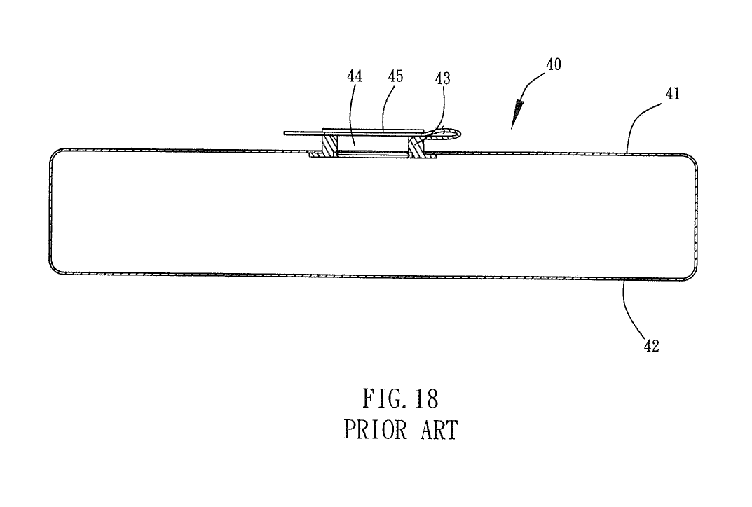

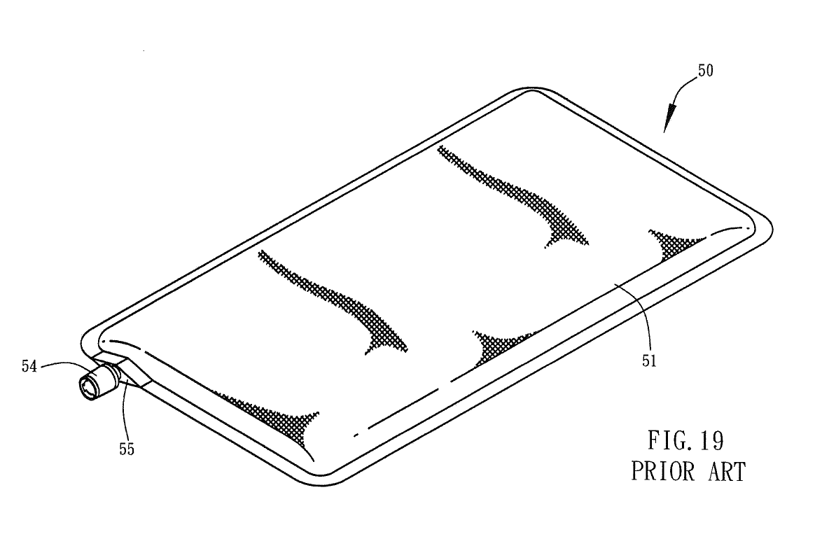

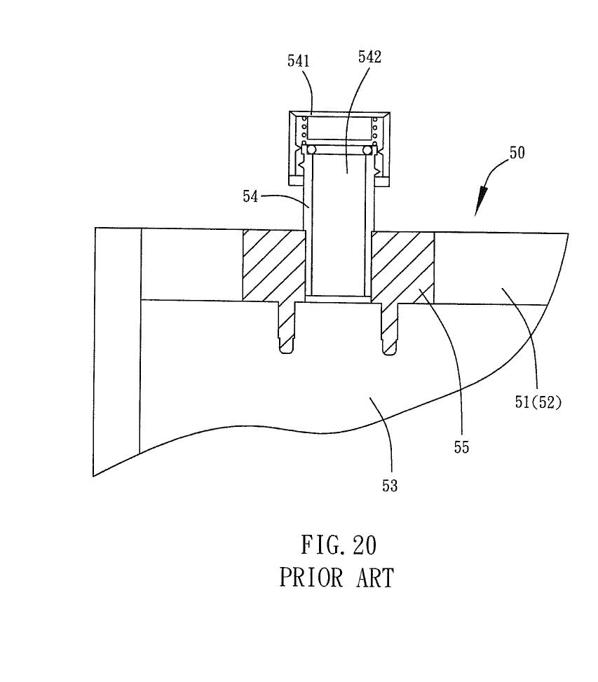

Referring to FIG. 16, the valve seat 22 is separated and disconnected from the base 21.

Accordingly, the air valve structure 20 functions as a oneway valve by action of the valve plate 24 to provide a oneway air inlet or outlet function so as to enhance the air inflation or deflation effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An air valve structure comprising:
a base, a valve seat, a valve cover and a valve plate; wherein:
the base is provided with a mounting hole;
the valve seat is provided with a first mounting portion and a second mounting portion;
the first mounting portion and the second mounting portion of the valve seat are mounted in the mounting hole of the base at different time;
the valve seat is provided with a vent hole;
the valve seat is provided with a support portion and an abutting edge each of which is disposed in the vent hole;
the support portion of the valve seat is provided with a through hole for mounting the valve plate;
the valve cover and the base are connected by a flexible connecting member; and
the valve cover is provided with a covering portion.

2. The air valve structure of claim 1, wherein the valve seat and the base are connected by a flexible connecting strip.

3. The air valve structure of claim 1, wherein the valve seat is separated and disconnected from the base.

4. The air valve structure of claim 1, wherein the valve seat has a side provided with a grip portion.

5. The air valve structure of claim 1, wherein the valve plate is made of soft material, including silicone, plastics or rubber, and is formed integrally with a limit post extending through the through hole of the support portion of the valve seat, and the limit post of the valve plate is provided with a limit protrusion.

6. The air valve structure of claim 1, wherein the valve plate has a diameter greater than an inner diameter of the abutting edge of the valve seat.

7. The air valve structure of claim 1, wherein the covering portion of the valve cover is mounted on the first mounting portion or the second mounting portion of the valve seat to seal the first mounting portion or the second mounting portion of the valve seat.

8. The air valve structure of claim 1, wherein the valve cover has a side provided with a grip portion.
